(19) United States
(12) Patent Application Publication
(10) Pub. No.: US 2026/0358495 A1
(43) Pub. Date: Nov. 12, 2026

(54) METHOD FOR DEPLOYING RADAR SYSTEM, AND SERVER SYSTEM FOR BUILDING RADAR SYSTEM

(71) Applicant: TRON FUTURE TECH INC., HSINCHU CITY (TW)

(72) Inventors: YU-JIU WANG, HSINCHU CITY (TW); CHUNG YAU LAU, HSINCHU CITY (TW)

(21) Appl. No.: 18/592,524

(22) Filed: Mar. 1, 2024

Related U.S. Application Data
(60) Provisional application No. 63/488,074, filed on Mar. 2, 2023.

(51) Int. Cl. G01S 13/89; G06Q 30/0601; G06T 11/23

(52) U.S. Cl. CPC G01S 13/89; G06Q 30/06333; G06T 11/23; G06T 2210/12

(57) ABSTRACT

A method for deploying a radar system includes: displaying, via a web browser, a radar surveillance area of the radar system on a map on a webpage according to a user input; automatically arranging a set of radar sectors on the map according to the radar surveillance area, wherein the radar surveillance area is fully covered by the set of radar sectors, and each radar sector is indicative of a coverage area and a location of a corresponding radar unit in a set of radar units of the radar system; and updating a quantity of at least one radar item in a shopping cart displayed on the webpage according to the set of radar sectors, wherein a quantity of each type of radar unit in the set of radar units is indicated by a quantity of a corresponding radar item in the shopping cart.

### PRIORITY CLAIM AND CROSS-REFERENCE

The present application claims priority to U.S. Provisional Patent Applications including Ser. No. 63/488,074, filed on Mar. 2, 2023, which is incorporated by reference herein in its entirety.

### BACKGROUND

The present disclosure relates to radar deployment and, more particularly, to a method for deploying a radar system, and a server system for building a radar system.

Radar technology can determine the range, angle and speed of objects by transmitting electromagnetic waves in the radio frequency spectrum, receiving the electromagnetic waves that bounce off the objects, and calculating the amount of time it takes for these radio signals to go out to the objects and bounce back. Radar technology comes in various types and configurations, and finds use in many applications, such as military, commercial, industrial, medical, weather and automotive systems. For example, a phased-array radar system can employ an array of antennas that electronically steer the radar beam. The phased-array radar system can be used for air traffic control, military surveillance, and missile defense.

### SUMMARY

The described embodiments provide a method for deploying a radar system, and a server system for building a radar system.

Some embodiments described herein may include a method for deploying a radar system. The method includes: displaying, via a web browser, a radar surveillance area of the radar system on a map on a webpage according to a user input; automatically arranging a set of radar sectors on the map according to the radar surveillance area, wherein the radar surveillance area is fully covered by the set of radar sectors, and each radar sector is indicative of a coverage area and a location of a corresponding radar unit in a set of radar units of the radar system; and updating a quantity of at least one radar item in a shopping cart displayed on the webpage according to the set of radar sectors, wherein a quantity of each type of radar unit in the set of radar units is indicated by a quantity of a corresponding radar item in the shopping cart.

Some embodiments described herein may include server system for building a radar system. The server system includes one or more processors, and a storage device. The storage device stores instructions that, when executed by the one or more processors, cause the one or more processors to: displaying, via a web browser running on a client system, a radar surveillance area of the radar system on a map on a webpage according to a user input; automatically arranging a set of radar sectors on the map according to the radar surveillance area, wherein the radar surveillance area is fully covered by the set of radar sectors, and each radar sector is indicative of a coverage area and a location of a corresponding radar unit in a set of radar units of the radar system; and updating a quantity of at least one radar item in a shopping cart displayed on the webpage according to the set of radar sectors, wherein a quantity of each type of radar unit in the set of radar units is indicated by a quantity of a corresponding radar item in the shopping cart.

With the use of the combination of the map and the shopping cart, the proposed radar deployment scheme not only can increase efficiency and accuracy in determining the number, types and locations of radar units, but also can facilitate the online radar purchase, thereby saving time and effort in building a radar system.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram illustrating an exemplary computer system for building a radar system in accordance with some embodiments of the present disclosure.

FIG. 2 is an implementation of a webpage displayed via the web browser shown in FIG. 1 in accordance with some embodiments of the present disclosure.

FIG. 3 is a flow chart of a method for deploying a radar system in accordance with some embodiments of the present disclosure.

FIG. 4 illustrates auxiliary grid cells involved in determination of the set of radar sectors shown in FIG. 2 in accordance with some embodiments of the present disclosure.

FIG. 5 is a flow chart of an exemplary method for providing a bounding box enclosing a radar surveillance area in accordance with some embodiments of the present disclosure.

FIG. 6 illustrates an implementation of a bounding box provided using the method shown in FIG. 5 in accordance with some embodiments of the present disclosure.

FIG. 7 is a flow chart of an exemplary method for determining a polygonal grid according to a boundary of a bounding box in accordance with some embodiments of the present disclosure.

FIG. 8A and FIG. 8B illustrate visualizations of the polygonal grid determined using the method shown in FIG. 7 in accordance with some embodiments of the present disclosure.

FIG. 9 is a flow chart of an exemplary method for arranging a set of radar sectors according to a set of circular sectors intersecting a radar surveillance area in accordance with some embodiments of the present disclosure.

FIG. 10 illustrates a visualization of the set of radar sectors arranged using the method shown in FIG. 9 in accordance with some embodiments of the present disclosure.

FIG. 11 is a diagram illustrating an exemplary computer system for building a radar system in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the present disclosure may repeat reference numerals and/or letters in the various examples. This repetition is for the purpose of simplicity and clarity and does not in itself dictate a relationship between the various embodiments and/or configurations discussed.

Further, it will be understood that when an element is referred to as being “connected to” or “coupled to” another element, it may be directly connected to or coupled to the other element, or intervening elements may be present.

When designing a radar system for monitoring an area of interest, determining the location and type of radar employed in the radar system can be a time-consuming process. This is primarily because the area of interest can be extensive and may vary depending on different applications. As a result, deciding on the location and type of radar not only consumes a significant amount of time but also may not guarantee accuracy.

The present disclosure describes exemplary methods for deploying a radar system. The exemplary method can automatically deploy a set of radars on a map, thereby building the radar system. In addition, the exemplary method can update a shopping cart displayed on a webpage in real time to streamline online radar purchases. For example, the shopping cart can show multiple radar items, each of which represents a corresponding radar model. The exemplary method can automatically update a quantity of at least one radar item in the shopping cart according to the set of radars displayed on the map. The quantity of each radar item in the shopping cart can serve as a recommendation for selecting a corresponding radar model that optimizes cost and radar location.

The present disclosure further describes exemplary systems for building a radar system. The exemplary system can be a server system, a client system or other computer systems. The exemplary system can automatically deploy a set of radars on a map according to a given surveillance area, and combine a map and a shopping cart to streamline online radar purchases. In some embodiments, billing can be conducted automatically in the shopping cart. Further description is provided below.

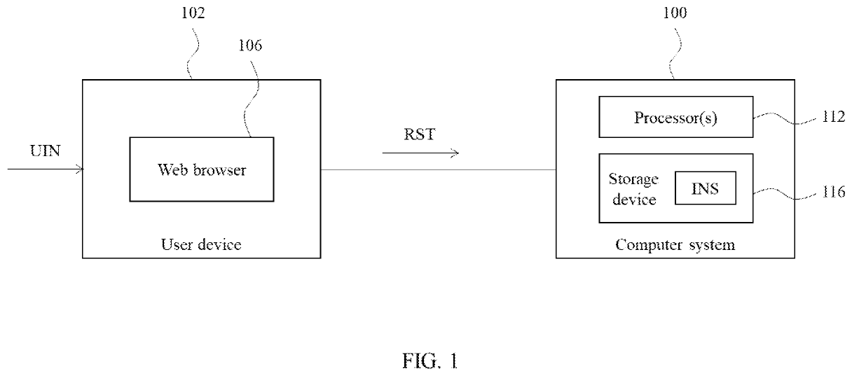

FIG. 1 is a diagram illustrating an exemplary computer system for building a radar system in accordance with some embodiments of the present disclosure. The computer system 100 can receive information on a surveillance area of interest, and accordingly provide recommended deployment of a set of radar units that covers the surveillance area of interest. In the present embodiment, the computer system 100 can be implemented as a server system (i.e. a computer system on a server side), and configured to deliver website contents to a user device 102 over the internet via a web browser 106. The user device 102 can be a computer, a consumer device, a mobile device or other types of electronic devices. The web browser 106 is configured to display websites (or webpages) on the user device 102, and interact with the websites. The computer system 100 can utilize the combination of a map and a shopping cart displayed on the website to facilitate the radar deployment and online radar purchase.

Note that the proposed radar deployment scheme can be employed in a client system (i.e. a computer system on a client side) or other types of computer systems without departing from the scope of the present disclosure. By way of example but not limitation, in some embodiments, the user device 102 can launch an application installed thereon to utilize the combination of a map and a shopping cart to facilitate the radar deployment and purchase.

The computer system 100 includes, but is not limited to, one or more processors 112 and a storage device 116. The one or more processors 112 may be implemented using central processing unit(s), graphic processing unit(s), general purpose processor(s), digital signal processor(s), microprocessor(s) or other types of processors. The storage device 116 may include any non-transitory computer readable medium capable of storing data, instructions, software programs, or combinations thereof. For example, the storage device 116 may be implemented by a memory device including a read-only memory (ROM), a random access memory (RAM), a flash memory, a content addressable memory (CAM), a disk memory, a memory card or any other types of memory devices suitable for storing information. In the example of FIG. 1, the storage device 116 stores instructions INS that can cause the one or more processors 112 to display, via the web browser 106 running on the user device 102, webpages of a website for radar deployment and purchase.

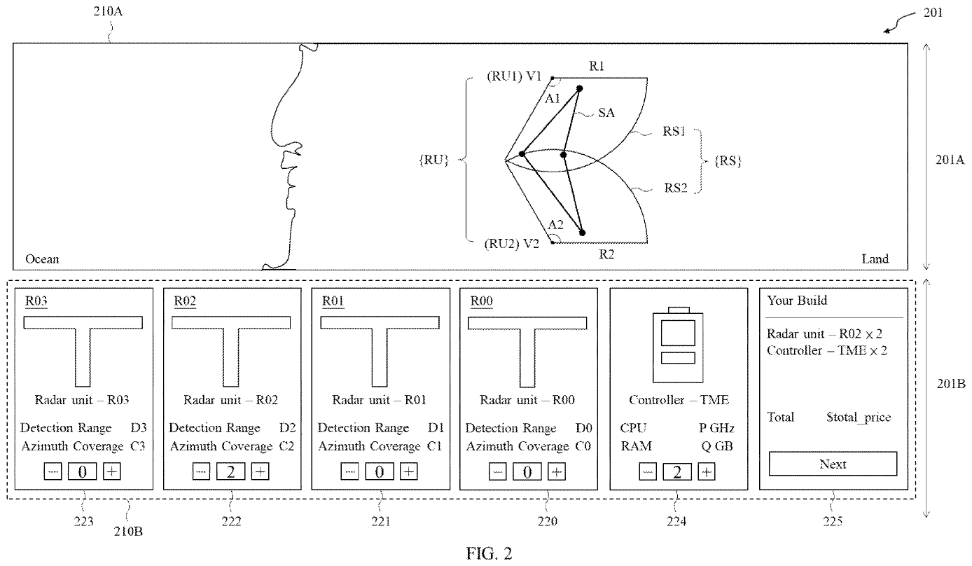

Referring to FIG. 2 and also to FIG. 1, when executed by the one or more processors 112, the instructions INS can cause the one or more processors 112 to perform radar deployment on a map 210A (depicting the land, ocean and coastline) that is displayed on the user device 102. For example, the instructions INS can cause the one or more processors 112 to display a webpage 201 on the user device 102 via the web browser 106. The webpage 201 includes a map section 201A and a shopping cart section 201B. Users are allowed to zoom and pan the map 210A shown in the map section 201A to see different details. The shopping cart 210B contained in the shopping cart section 201B includes, but is not limited to, a plurality of radar items 220 to 223 and a controller item 224.

Each radar item represents a radar unit of a specific radar model, i.e. one of the radar models R00 to R03. A radar unit of the radar model R00 has a detection range D0 and an azimuth coverage C0; a radar unit of the radar model R01 has a detection range D1 and an azimuth coverage C1; a radar unit of the radar model R02 has a detection range D2 and an azimuth coverage C2; a radar unit of the radar model R03 has a detection range D3 and an azimuth coverage C3. Radar units of different radar models can be regarded as belonging to different types of radar units. Each radar unit is represented by a T-shaped radar unit for illustrative purposes. Those skilled in the art can appreciated one or more radar units can be implemented using other types of radar units without departing from the scope of the present disclosure. In addition, the controller item 224 represents a radar controller of a specific controller model TME. A radar controller of the controller model TME has a central processing unit (CPU) with a processor frequency of P GHz, and has a random access memory (RAM) with a memory size of Q GB.

In the example of FIG. 2, the detection ranges D0 to D3 can be 2 km, 3 km, 4 km and 5 km respectively, and each of the azimuth coverages C0 to C3 can be 120°. However, this is provided for illustrative purposes, and is not intended to limit the scope of the present disclosure. Those skilled in the art will appreciate that various radar models, each of which corresponds to a different detection range and/or a different azimuth coverage, can be employed for radar deployment without departing from the scope of the present disclosure.

In operation, the user device 102 can receive a user input UIN when a user draws the radar surveillance area SA on the map 210A. The web browser 106 can send a request RST to the computer system 100 in response to the user input UIN. The computer system 100 can determine the deployment location and model of each radar unit of the radar system according to the request RST, which is indicative of the radar surveillance area SA (i.e. a surveillance area designated by the user). In addition, the computer system 100 can automatically deploy a set of radar sectors (each representing a coverage of a physical radar unit) on the map 210A to fully cover the radar surveillance area SA, and accordingly update a quantity of at least one radar item the shopping cart 210B.

For example, when executed by the one or more processors 112, the instructions INS can cause the one or more processors 112 to display, via the web browser 106, the radar surveillance area SA on the map 210A according to the user input UIN. The radar surveillance area SA can be, but is not limited to, a polygonal area drawn by the user. In addition, the instructions INS can cause the one or more processors 112 to automatically arrange a set of radar sectors {RS} on the map 210A according to the radar surveillance area SA. The radar surveillance area SA is fully covered by the set of radar sectors {RS} that includes the radar sectors RS1 and RS2. The radar sector RS1 is indicative of a coverage area and a location of a radar unit RU1; the radar sector RS2 is indicative of a coverage area and a location of a radar unit RU2. The radar units RU1 and RU2 are included in a set of radar units {RU} of the radar system to be built.

In the present embodiment, each of the radar sectors RS1 and RS2 can be a circular sector. An area and a vertex position of the circular sector correspond to a coverage area and a location of a corresponding radar unit, respectively. For example, the radar sector RS1 is a circular sector with a radius R1 and a central angle A1. The radius R1 and the central angle A1 represent a detection range and an azimuth coverage of the radar unit RU1, respectively. An area and a vertex position (i.e. a position of the vertex V1) of the radar sector RS1 correspond to the coverage area and the location of the radar unit RU1, respectively. Similarly, the radar sector RS2 can be a circular sector with a radius R2 and a central angle A2. The radius R2 and the central angle A2 represent a detection range and an azimuth coverage of the radar unit RU2, respectively. An area and a vertex position (i.e. a position of the vertex V2) of the radar sector RS2 correspond to the coverage area and the location of the radar unit RU2, respectively.

Moreover, the instructions INS can cause the one or more processors 112 to update a quantity of at least one radar item in the shopping cart 210B according to the set of radar sectors {RS}. A quantity of each type of radar unit in the set of radar units {RU} is indicated by a quantity of a corresponding radar item in the shopping cart 210B. By way of example but not limitation, each of the radar sectors RS1 and RS2 can represent a radar unit of the radar model R02, and hence is indicative of a same detection range and a same azimuth coverage. In other words, the radii R1 and R2 are equal, and represent the same detection range D2; the central angles A1 and A2 are equal, and represent the same azimuth coverage C2. Thus, the quantity of the radar item 222 is automatically set to two.

The instructions INS can further cause the one or more processors 112 to update a quantity of a controller item in the shopping cart 210B according to the set of radar sectors {RS}. A quantity of radar controllers for controlling the set of radar units {RU} is indicated by a quantity of the controller item 224 in the shopping cart 210B. By way of example but not limitation, a radar controller used for controlling a radar unit can be located near the radar unit. In other words, two radar controllers may be used for controlling the radar units RU1 and RU2. The quantity of the controller item 224 can be automatically set to two.

In some embodiments, billing can be conducted automatically in the shopping cart 210B. For example, the instructions INS can further cause the one or more processors 112 to update the billing information 225 shown in the shopping cart 210B. The billing information 225 can indicate the quantity and total price of selected items in the shopping cart 210B. In the embodiment shown in FIG. 2, the billing information 225 indicates that two radar units of the radar model R02 and two radar controller of the controller model TME are selected, and that the total price is $total_price. The user may click on “Next” button to go to a webpage, such as a checkout page or a shipping page. Note that the proposed radar deployment scheme can determine or calculate the optimal radar sector placement for fully covering the radar surveillance area SA. For example, the set of radar units {RU} corresponding to the set of radar sectors {RS} can be a minimum cost set of radar units for fully covering the radar surveillance area SA. As another example, the selected radar items and their quantities displayed on the webpage 201 can serve as a recommendation for selecting one or more radar models that can optimize cost and radar location.

The above examples are provided for illustrative purposes, and are not intended to limit the scope of the present disclosure. In some embodiments, one of the radar models R00-R03 can have an azimuth coverage different from that of another of the radar models R00-R03. In some embodiments, more than one controller item can be shown in the shopping cart 210B when multiple controller models can be provided for radar control. Different controller models can have different processor frequencies and/or memory sizes. In some embodiments, a set of radar sectors that is arranged on a map may be a singleton set when it is determined that a radar surveillance area can be fully covered by a single radar sector. In some embodiments, a user is allowed to manually change the quantity of each item in the shopping cart 210B.

With the use of the combination of the map and the shopping cart, the proposed radar deployment scheme not only can increase efficiency and accuracy in determining the number, types and locations of radar units, but also can facilitate the online radar purchase, thereby saving time and effort in building a radar system.

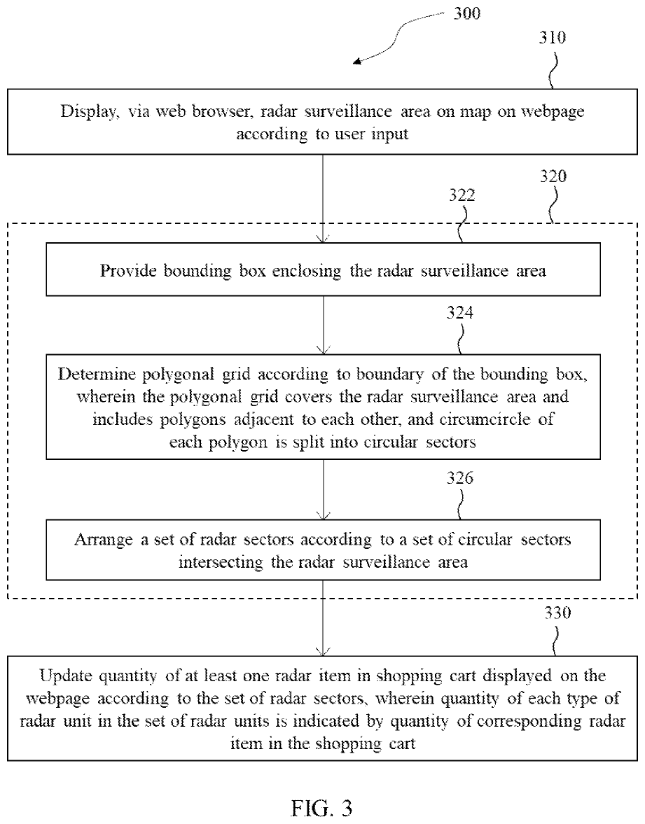

FIG. 3 is a flow chart of a method for deploying a radar system in accordance with some embodiments of the present disclosure. For illustrative purposes, the method 300 is described below with reference to the computer system 100 shown in FIG. 1 and the radar system including the set of radar units {RU} shown in FIG. 2. Note that the method 300 can be employed by other computer systems or non-transitory computer readable mediums, thereby building radar systems and facilitating radar purchases without departing from the scope of the present disclosure. Additionally, in some embodiments, other steps can be performed in the method 300. In some other embodiments, steps of the method 300 can be performed in a different order and/or vary.

Referring to FIG. 3 and also to FIG. 1 and FIG. 2, in step 310, the radar surveillance area SA is displayed, via the web browser 106, on the map 210A according to the user input UIN. For example, the user can draw the radar surveillance area SA on the map 210A via the web browser 106 by drawing a contour of the radar surveillance area SA, or by clicking on multiple points on the map 210A that serve as vertices of the radar surveillance area SA. The computer system 100 can receive the request RST, which is sent from the user device 102 in response to the user input UIN. The request RST can contain information on the radar surveillance area SA. In addition, the computer system 100 can be configured to display, via the web browser 106, the radar surveillance area SA on the map 210A according to the request RST.

In step 320, the set of radar sectors {RS} is automatically arranged on the map 210A according to the radar surveillance area SA. For example, the computer system 100 can refer to the information on the radar surveillance area SA to determine a set of radar sectors that can fully cover the radar surveillance area SA. The computer system 100 can arrange and display the resulting set of radar sectors (i.e. the set of radar sectors {RS}) on the map 210A via the web browser 106. Each radar sector is indicative of a coverage area and a location of a corresponding radar unit in the set of radar units {RU}. In the example of FIG. 2, the radar sector RS1 is indicative of a coverage area and a location of the radar unit RU1; the radar sector RS2 is indicative of a coverage area and a location of the radar unit RU2.

In step 330, a quantity of at least one radar item in the shopping cart 210B displayed on the webpage 201 is updated according to the set of radar sectors {RS}. In other words, when a set of radar sectors arranged on the map 210A includes N radar sectors that represent radar units of a certain radar model, the quantity of a radar item that corresponds to a radar unit of the certain radar model can be set to N. In the example of FIG. 2, the computer system 100 can update the quantity of the radar item 222 in the shopping cart 210B to be equal to the number of radar sectors that represent radar units of the radar model R02. The radar units RU1 and RU2 to be deployed are regarded as belonging to the same type of radar units.

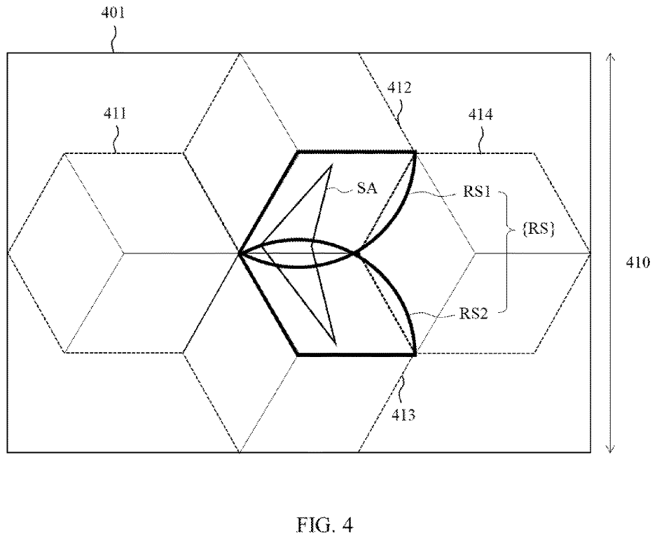

In some embodiments, the set of radar sectors can be arranged automatically in step 320 with the use of some algorithms, such as heuristic, metaheuristic and exact algorithms. By way of example but not limitation, step 320 may include steps 322 to 326 that can be executed by the computer system 100 to arrange a suitable or optimal set of radar sectors on a map. Steps 322 to 326 may implement a heuristic method to save time and effort in selecting a suitable or optimal set of radar sectors. For illustrative purposes, steps 322 to 326 are described below with reference to FIG. 4, which shows some auxiliary grid cells involved in determination of the set of radar sectors {RS} shown in FIG. 2 in accordance with some embodiments of the present disclosure.

Referring to FIG. 3 and also to FIG. 1 and FIG. 4, in step 322, a bounding box that encloses a radar surveillance area is provided. For example, the computer system 100 can provide a bounding box 401 that enclose the radar surveillance area SA. A centroid (or a center of mass) of the bounding box 401 may overlap with a circumcenter of the radar surveillance area SA. In the example of FIG. 4, the bounding box 401 can be, but is not limited to, a rectangle.

In step 324, a polygonal grid is determined according to a boundary of the bounding box. The polygonal grid can cover the radar surveillance area and include a plurality of polygons adjacent to each other. A circumcircle of each polygon is split into a plurality of circular sectors.

For example, the computer system 100 can determine a polygonal grid 410 according to a boundary of the bounding box 401. The polygonal grid 410 can cover the radar surveillance area SA, and include a plurality of polygons 411 to 414 (represented by dotted outlines) adjacent to each other. Each polygon is a grid cell of the polygonal grid 410, and each edge of the polygon falls within or on the boundary of the bounding box 401. In addition, a circumcircle of the polygon 412 (not shown in FIG. 4) can be split into a plurality of circular sectors, one of which serves as the radar sector RS1. Similarly, a circumcircle of the polygon 413 (not shown in FIG. 4) can be split into a plurality of circular sectors, one of which serves as the radar sector RS2. In the example of FIG. 4, the polygonal grid 410 can be a hexagonal grid formed by a tessellation of regular hexagons. Each hexagon can be divided into three equal parts to thereby from three equal circular sectors. Thus, each circular sector has a central angle of 120°, and can represent a radar unit having an azimuth coverage of 120°.

In step 326, the set of radar sectors is arranged according to a set of circular sectors intersecting the radar surveillance area. For example, the computer system 100 can use a set of circular sectors intersecting the radar surveillance area SA as the set of radar sectors {RS}. With the use of the approach implemented using steps 322 to 326, a suitable or optimal set of radar sectors can be arranged automatically on the webpage 201. Thus, the number, types and locations of radar units to be deployed can be determined efficiently.

In some embodiments, the computer system 100 may create other types of polygonal grid according to a boundary of a bounding box. For example, the computer system 100 may determine a square grid that includes regular squares adjacent to each other. A circumcircle of each square may be divided into four equal parts to form four equal circular sectors. Each circular sector has a central angle of 90°, and hence can represent a radar unit having an azimuth coverage of 90°. The computer system 100 can use a set of circular sectors intersecting a radar surveillance area as a set of radar sectors, thereby building a radar system.

To facilitate understanding of the present disclosure, some implementations for determination and arrangement of radar sectors are given as follows for further description of the proposed radar deployment scheme. Those skilled in the art should appreciate that other implementations, each of which can refer to a surveillance area of interest to arrange a set of radar sectors, are also within the contemplated scope of the present disclosure.

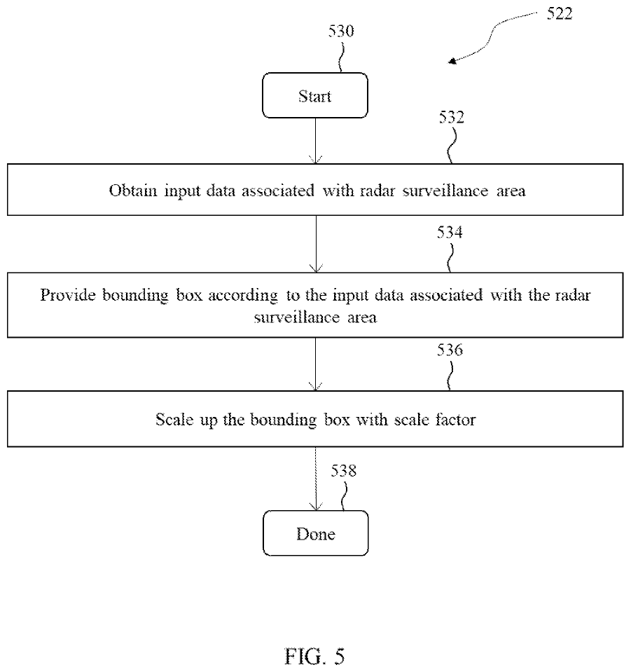

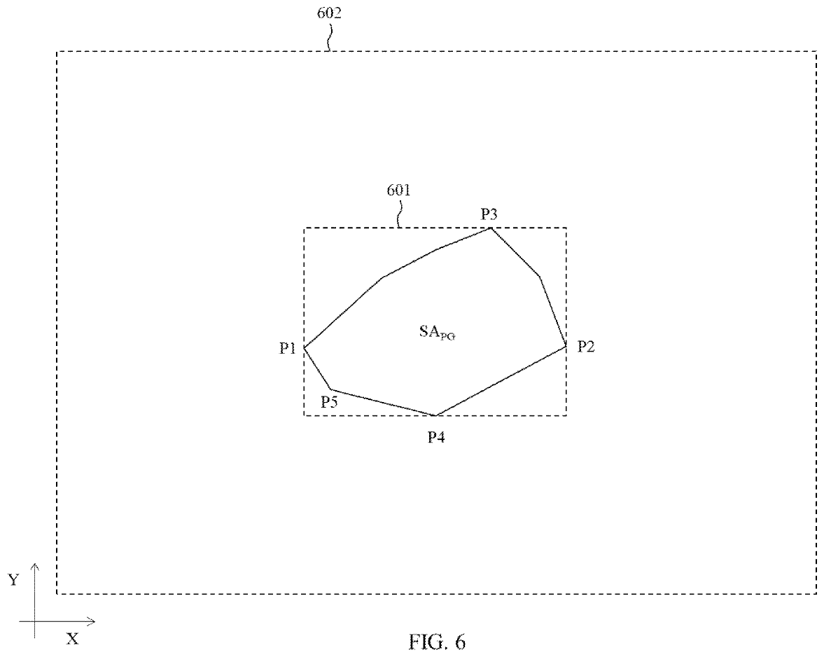

FIG. 5 is a flow chart of an exemplary method for providing a bounding box enclosing a radar surveillance area in accordance with some embodiments of the present disclosure. The method 522 can serve as an implementation of step 322 shown in FIG. 3. For illustrative purposes, the method 522 is described below with reference to a radar surveillance area SA_{PG} shown in FIG. 6 (e.g. a surveillance area of interest drawn by the user on the map 210A shown in FIG. 2). Those skilled in the art will appreciate that the computer system 100 shown in FIG. 1 can employ the method 522 to provide a bounding box enclosing a radar surveillance area, such as the radar surveillance area SA shown in FIG. 2. Additionally, in some embodiments, other steps can be performed in the method 522. In some other embodiments, steps of the method 522 may vary.

The method 522 can start from step 530. Referring to FIG. 5 and also to FIG. 1 and FIG. 6, in step 532, input data associated with the radar surveillance area SA_{PG} is obtained. For example, the user can draw the radar surveillance area SA_{PG} on a map displayed via the web browser 106, and the computer system 100 can receive from the user device 102 the request RST that can contain the input data associated with the radar surveillance area SA_{PG}. In the example of FIG. 6, the radar surveillance area SA_{PG} can be a polygon.

In step 534, a bounding box 601 is provided according to the input data associated with the radar surveillance area SA_{PG}. In the example of FIG. 6, the bounding box 601 is a circumscribed rectangle of the radar surveillance area SA_{PG}. For example, the computer system 100 can determine the leftmost, rightmost, topmost and bottommost vertices (i.e. the vertices P1 to P4) of the radar surveillance area SA_{PG} on a plane formed by the X-axis and Y-axis, and provide the bounding box 601 whose edges pass through the leftmost, rightmost, topmost and bottommost vertices respectively.

In step 536, the bounding box 601 is scaled up with a scale factor to provide a bounding box 602 that is suitable for polygonal grid generation. The scale factor may be determined according to a shortest edge length of the radar surveillance area SA_{PG} and a maximum detection range of radar units that are available for building a radar system. By way of example but not limitation, the scale factor can be determined by the following expression:

$$DF = \frac{{EL}_{S} + m \times {D}_{M}}{{EL}_{S}} ,$$

where SF represents the scaling factor, ELs represents a shortest edge length of the radar surveillance area SA_{PG} (i.e. the distance between the vertices P1 and P5), m can be a positive number or positive integer, and DM represents a maximum detection range of radar items in a shopping cart. In some examples where the detection ranges DO to D3 shown in FIG. 2 are 2 km, 3 km, 4 km and 5 km respectively, the shortest edge length can be represented in km, and DM can be set to 5. In the example of FIG. 6, respective centers of the bounding boxes 601 and 602 are in the same position. Next, the flow may proceed to step 538, and the method 522 ends.

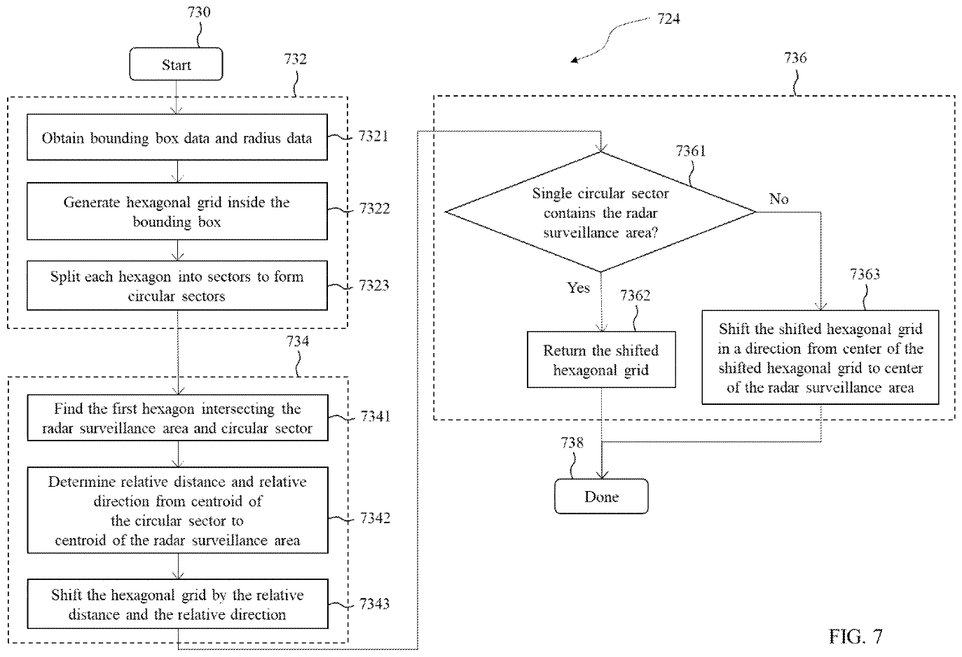

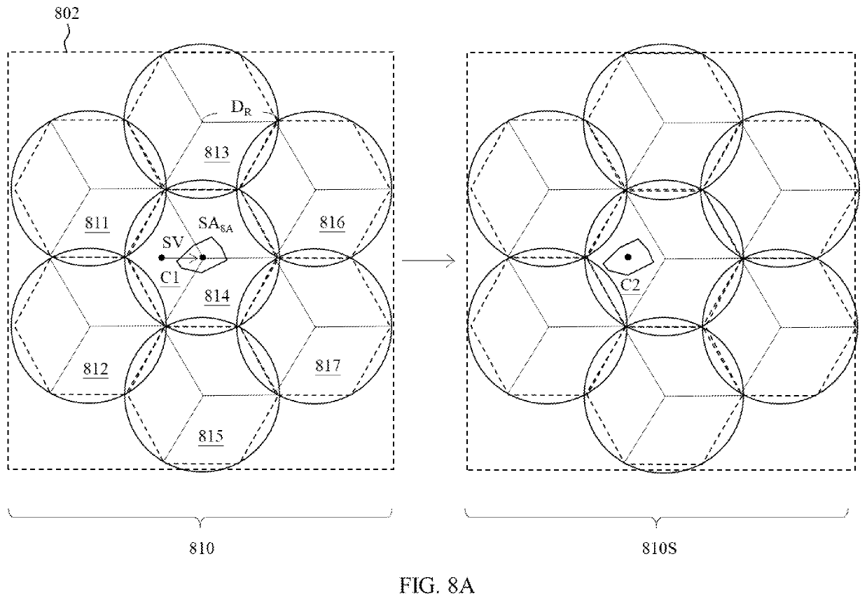

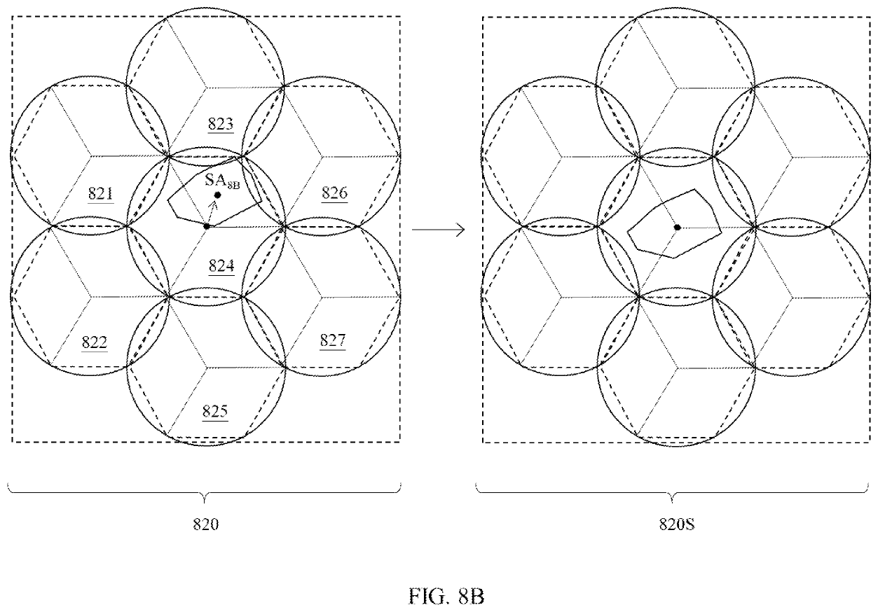

FIG. 7 is a flow chart of an exemplary method for determining a polygonal grid according to a boundary of a bounding box in accordance with some embodiments of the present disclosure. FIG. 8A and FIG. 8B illustrate visualizations of the polygonal grid determined using the method 724 shown in FIG. 7 in accordance with some embodiments of the present disclosure. The method 724, starting from step 730, can serve as an implementation of step 324 shown in FIG. 3. Note that in some embodiments, other steps can be performed in the method 724. In some other embodiments, steps of the method 724 may vary.

Firstly, referring to FIG. 7 and FIG. 8A, in step 732, a polygonal grid (e.g. a hexagonal grid 810) can be provided inside a bounding box 802. The bounding box 802 that encloses a radar surveillance area SABA (e.g. a surveillance area drawn by the user on the map 210A shown in FIG. 2) can be determined according to the method 522 shown in FIG. 5. The polygonal grid includes a plurality of polygons adjacent to each other, and a circumcircle of each polygon is split into a plurality of circular sectors.

By way of example but not limitation, steps 7321 to 7323 can be used to implement step 732. In step 7321, bounding box data (i.e. data associated with the bounding box 802) and radius data are obtained. The radius data can be a detection range DR selected from among the detection ranges DO to D3 shown in FIG. 2. In step 7322, the hexagonal grid 810, including a plurality of hexagons 811 to 817 adjacent to each other, can be generated inside the bounding box 802. The hexagonal grid 810 is bounded by the boundary of the bounding box 802, and is formed by a tessellation of regular hexagons (i.e. the hexagons 811 to 817), each having a side length equal to the detection range DR. In step 7323, each hexagon is split into sectors to thereby form circular sectors of a circumcircle. Each circular sector has a central angle of 120°, and hence can represent a radar unit having an azimuth coverage of 120°.

The polygonal grid obtained in step 732 can be shifted according to a relative position of a center of the radar surveillance area SABA with respect to a center of a circular sector intersecting the radar surveillance area SABA (step 734).

By way of example but not limitation, steps 7341 to 7343 can be used to implement step 734. In step 7341, the computer system 100 shown in FIG. 1 can search for, among the hexagonal grid 810, a predetermined hexagon intersecting the radar surveillance area SA_{8A}. For example, a hexagon that intersect the radar surveillance area SABA can be searched for in predetermined order, from top to bottom and left to right, beginning at the top left hexagon (i.e. the hexagon 811). The first hexagon intersecting the radar surveillance area SABA (i.e. the hexagon 814) can serve as the predetermined hexagon. In addition, the computer system 100 shown in FIG. 1 can search for, among circular sectors in the predetermined hexagon that intersect the radar surveillance area SABA (i.e. the hexagon 814), a predetermined circular sector intersecting the radar surveillance area SA_{8A}. For example, a circular sector that intersects the radar surveillance area SABA can be searched for in clockwise order beginning at the leftmost circular sector (i.e. the circular sector C1). The first circular sector intersecting the radar surveillance area SA_{8A} (i.e. the circular sector C1) can serve as the predetermined circular sector.

Next, in step 7342, the computer system 100 shown in FIG. 1 can determine a relative distance and a relative direction from a centroid (or a center of mass) of the circular sector found in step 7341 (e.g. the circular sector C1) to a centroid of the radar surveillance area SA_{8A}. In step 7343, the polygonal grid (e.g. the hexagonal grid 810) can be shifted by the relative distance in the relative direction. For example, the hexagonal grid 810 can be shifted by a relative distance in a relative direction (represented using a vector SV) to form a shifted hexagonal grid 810S.

In step 736, the polygonal grid obtained in step 324 shown in FIG. 3 is provided according to the shifted polygonal grid obtained in step 734. By way of example but not limitation, steps 7361 to 7363 can be used to implement step 736. In step 7361, the computer system 100 shown in FIG. 1 can determine if a radar surveillance area of interest is enclosed by a single circular sector associated with the shifted polygonal grid.

When it is determined that the radar surveillance area of interest is enclosed by a single circular sector associated with the shifted polygonal grid, the method 724 proceeds to step 7362, in which the shifted polygonal grid is used as the polygonal grid that is obtained in step 324 shown in FIG. 3. Data associated with the shifted polygonal grid is returned and provided for use in step 326 shown in FIG. 3.

For example, the radar surveillance area SASA shown in FIG. 8A is enclosed by a single circular sector associated with the shifted hexagonal grid 810S (i.e. the circular sector C2). Thus, the shifted hexagonal grid 810S can serve as the polygonal grid that is obtained in step 324 shown in FIG. 3. Next, the flow may proceed to step 738 to complete the determination of the polygonal grid.

When it is determined that the radar surveillance area of interest is intersected by (or overlaps with) more than one circular sector associated with the shifted polygonal grid, the method 724 proceeds to step 7363, in which the shifted polygonal grid is shifted in a direction from a center of the shifted polygonal grid to a center of the radar surveillance area of interest, thereby providing the polygonal grid that is obtained in step 324 shown in FIG. 3. Data associated with the shifted polygonal grid is returned and provided for use in step 326 shown in FIG. 3.

For example, referring to FIG. 7 and also to FIG. 8B, the hexagonal grid 820 including adjacent hexagons 821 to 827 can be a shifted hexagonal grid that is determined using steps 732 and 734. As the radar surveillance area SA_{8B} is enclosed by more than one circular sector associated with the shifted polygonal grid, the shifted polygonal grid is shifted in a direction from a center of the shifted polygonal grid (i.e. the hexagonal grid 820) to a center of the radar surveillance area SA_{8B}, thereby providing the polygonal grid 820S that can serve as the polygonal grid obtained in step 324 shown in FIG. 3. Next, the flow may proceed to step 738 to complete the determination of the polygonal grid.

In some embodiments, the method 724 shown in FIG. 7 can be performed multiple times to determine an optimal or suitable polygonal grid. By way of example but not limitation, when the detection ranges DO to D3 shown in FIG. 2 are 2 km, 3 km, 4 km and 5 km respectively, a minimum detection range (i.e. 2 km) can be firstly used as the radius data in step 732, and a first hexagonal grid is determined in step 736. When a radar surveillance area of interest is enclosed by more than one circular sector associated with the first hexagonal grid, the method 734 can be performed again to determine a second hexagonal grid, and the second shortest detection range (i.e. 3 km) can be used as the radius data in step 732. Similarly, when a radar surveillance area of interest is enclosed by more than one circular sector associated with the second hexagonal grid, the method 734 can be performed again to determine a third hexagonal grid, and the third shortest detection range (i.e. 4 km) can be used as the radius data in step 732. A hexagonal grid, which corresponds to the least number of circular sectors overlapping with a radar surveillance area of interest, can be selected as the optimal or suitable polygonal grid.

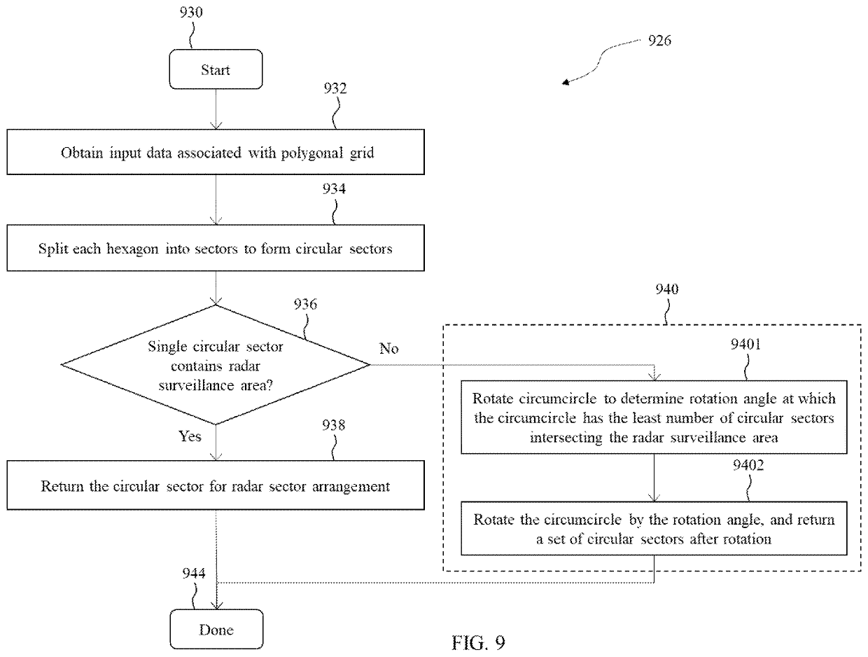

FIG. 9 is a flow chart of an exemplary method for arranging a set of radar sectors according to a set of circular sectors intersecting a radar surveillance area in accordance with some embodiments of the present disclosure. The method 926, starting from step 930, can serve as an implementation of step 326 shown in FIG. 3. Note that in some embodiments, other steps can be performed in the method 926. In some other embodiments, steps of the method 926 may vary.

In step 932, input data associated with the polygonal grid generated in step 324 (e.g. an optimal hexagonal grid) is obtained. In step 934, each hexagon of the polygonal grid is split into sectors to thereby form circular sectors of a circumcircle. For example, referring to FIG. 9 and also to FIG. 8A, input data associated with the hexagonal grid 810S can be obtained, and each hexagon of the hexagonal grid 810S can be split into sectors to thereby form circular sectors of a circumcircle. Each circular sector can have a central angle of 120°, and hence represent a radar unit having an azimuth coverage of 120°. In some embodiments, the input data obtained in step 932 may include circular sector data associated with the polygonal grid. In other words, step 934 can be optional.

In step 936, the polygonal grid is checked to determine if a radar surveillance area of interest is enclosed by a single circular sector associated with the polygonal grid. When it is determined that the radar surveillance area of interest is enclosed by a single circular sector associated with the polygonal grid, the method 926 proceeds to step 938, in which data associated with the single circular sector is returned and provided for radar sector arrangement in step 326 shown in FIG. 3. For example, referring to FIG. 9 and also to FIG. 8A, the radar surveillance area SABA is enclosed by the single circular sector C2. Thus, the circular sector C2 can serve as a radar sector to be arranged on a map or webpage. Next, the flow may proceed to step 944 to complete the radar sector arrangement.

When it is determined that the radar surveillance area of interest overlaps with more than one circular sector associated with the polygonal grid, the method 926 proceeds to step 940, in which at least one circumcircle associated with a set of first circular sectors intersecting the radar surveillance area is rotated to form a set of second circular sectors intersecting the radar surveillance area. The number of second circular sectors is less than the number of first circular sectors. The set of second circular sectors can be used as the set of radar sectors.

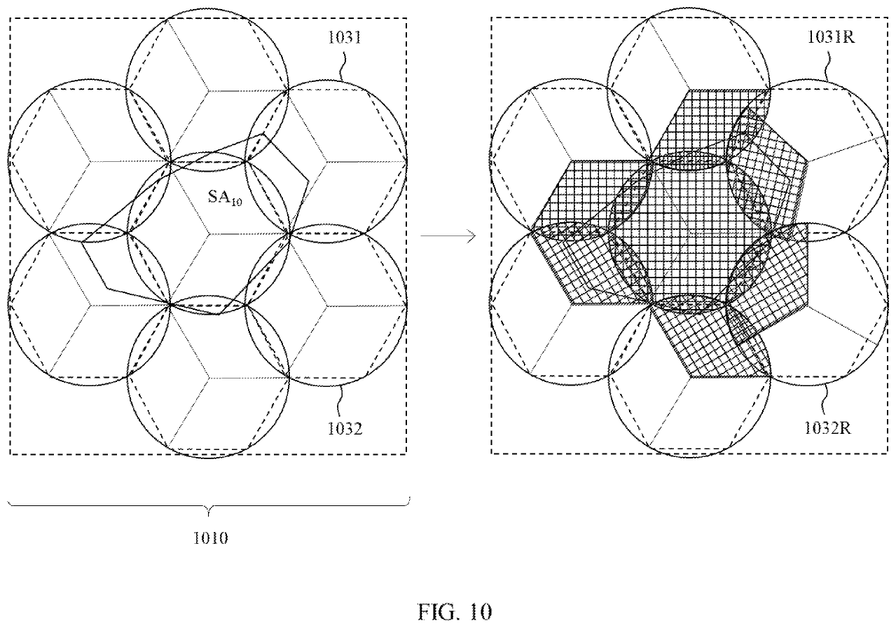

For example, referring to FIG. 9 and FIG. 10, step 940 may include steps 9401 and 9402 that are performed to rotate the circumcircles 1031 and 1032 to reduce the number of circular sectors intersecting the radar surveillance area SA10. When it is determined that the radar surveillance area SA10 overlaps with multiple circular sectors associated with the hexagonal grid 1010 (step 936), each circumcircle is rotated to determine a rotation angle at which the circumcircle has the least number of circular sectors intersecting the radar surveillance area SA10 (step 9401). Alternatively, when it is determined that the radar surveillance area SA10 overlaps with multiple circular sectors associated with the hexagonal grid 1010 (step 936), a circumcircle that has multiple circular sectors intersecting the radar surveillance area SA10 is rotated to determine an rotation angle at which the circumcircle has the least number of circular sectors intersecting the radar surveillance area SA10 (step 9401).

In step 9402, at least one circumcircle is rotated by a corresponding rotation angle determined in step 9401. After rotation of the at least one circumcircle is completed, a set of circular sectors that intersects the radar surveillance area SA10 can be used as a set of radar sectors. In the example of FIG. 10, the circumcircles 1031 and 1032, each of which includes multiple circular sectors intersecting the radar surveillance area SA10, are rotated to form the circumcircles 1031R and 1032R respectively. Each of circumcircles 1031 and 1032 can include only one circular sector that intersects the radar surveillance area SA10. Next, a set of circular sectors (filled with squares) can be used as a set of radar sectors. The flow may proceed to step 944 to complete the radar sector arrangement.

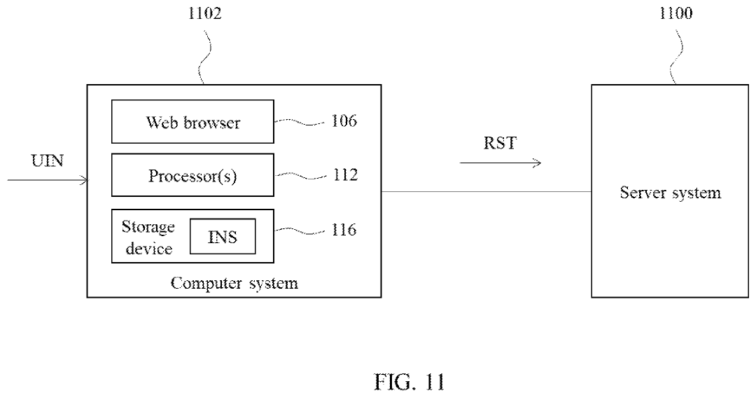

In some embodiments, the proposed radar deployment scheme can be employed on a client side to perform automatic radar deployment. FIG. 11 is a diagram illustrating an exemplary computer system for building a radar system in accordance with some embodiments of the present disclosure. The computer system 1102 can be implemented as a user device that includes the web browser 106, the one or more processors 112, and the storage device 116 shown in FIG. 1. The computer system 1102 can receive website contents from the server system 1100 (e.g. a computer system on a server side) over the internet via the web browser 106. The computer system 1102 can launch an application installed thereon to utilize the combination of a map and a shopping cart to facilitate the radar deployment and purchase.

For example, when executed by the one or more processors 112, the instructions INS can cause the one or more processors 112 to perform the method 300 shown in FIG. 3, the method 522 shown in FIG. 5, the method 724 shown in FIG. 7, and the method 926 shown in FIG. 9 to thereby build the radar system. In addition, when a set of radar sectors is arranged on a map/webpage displayed via the web browser 106, the computer system 1102 can send a request to the server system 1100 to thereby update shopping cart information stored in the server system 1100. Note that in some embodiments, the computer system 1102 can download map data for offline use from the server system 1100. The map data or offline map can be stored in the storage device 116. Thus, the computer system 1102 can perform automatic radar deployment with the use of the locally stored map data.

As those skilled in the art can appreciate operation of the computer system 1102 after reading above paragraphs directed to FIG. 1 to FIG. 10, further description is omitted here for brevity.

With the use of the proposed radar deployment scheme, a suitable or optimal set of radar sectors can be arranged automatically, such that the number, types and locations of radar units to be deployed can be determined efficiently. In addition, the proposed radar deployment scheme can combine the map and the shopping cart to facilitate the online radar purchase, thereby saving time and effort in building a radar system.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for deploying a radar system, comprising:
displaying, via a web browser, a radar surveillance area on a map on a webpage according to a user input;
automatically arranging a set of radar sectors on the map according to the radar surveillance area, wherein the radar surveillance area is fully covered by the set of radar sectors, and each radar sector is indicative of a coverage area and a location of a corresponding radar unit in a set of radar units of the radar system; and
updating a quantity of at least one radar item in a shopping cart displayed on the webpage according to the set of radar sectors, wherein a quantity of each type of radar unit in the set of radar units is indicated by a quantity of a corresponding radar item in the shopping cart.

2. The method of claim 1, wherein each radar sector is a circular sector, and an area and a vertex position of the circular sector correspond to a coverage area and a location of a corresponding radar unit, respectively.

3. The method of claim 1, wherein each radar sector in the set of radar sector is indicative of a same azimuth coverage.

4. The method of claim 1, wherein each radar sector in the set of radar sector is indicative of a same detection range.

5. The method of claim 1, wherein the step of automatically arranging the set of radar sectors on the map according to the radar surveillance area comprises:
providing a bounding box enclosing the radar surveillance area;
determining a first polygonal grid according to a boundary of the bounding box, wherein the first polygonal grid covers the radar surveillance area and comprises a plurality of first polygons adjacent to each other, and a circumcircle of each first polygon is split into a plurality of first circular sectors; and
arranging the set of radar sectors according to a set of first circular sectors intersecting the radar surveillance area.

6. The method of claim 5, wherein the first polygonal grid is a hexagonal grid formed by a tessellation of regular hexagons.

7. The method of claim 5, wherein the step of providing the bounding box to enclose the radar surveillance area comprises:
providing a circumscribed rectangle of the radar surveillance area; and
scaling up the circumscribed rectangle with a scale factor to provide the bounding box, wherein the scale factor is determined according to a shortest edge length of the radar surveillance area and a maximum detection range of radar items in the shopping cart.

8. The method of claim 5, wherein the step of determining the first polygonal grid according to the boundary of the bounding box comprises:
providing a second polygonal grid inside the bounding box, wherein the second polygonal grid comprises a plurality of second polygons adjacent to each other, and a circumcircle of each second polygon is split into a plurality of second circular sectors;
shifting the second polygonal grid according to a relative position of a center of the radar surveillance area with respect to a center of a second circular sector intersecting the radar surveillance area; and
providing the first polygonal grid according to the shifted second polygonal grid.

9. The method of claim 8, wherein the step of providing the first polygonal grid according to the shifted second polygonal grid comprises:
when the radar surveillance area is enclosed by a single second circular sector associated with the shifted second polygonal grid, using the shifted second polygonal grid as the first polygonal grid; and
when the radar surveillance area is intersected by more than one second circular sector associated with the shifted second polygonal grid, shifting the shifted second polygonal grid in a direction from a center of the shifted second polygonal grid to the center of the radar surveillance area to provide the first polygonal grid.

10. The method of claim 5, wherein the step of arranging the set of radar sectors according to the set of first circular sectors comprises:
rotating at least one circumcircle associated with the set of first circular sectors to form a set of second circular sectors intersecting the radar surveillance area, wherein a number of second circular sectors is less than a number of first circular sectors; and
using the set of second circular sectors as the set of radar sectors.

11. The method of claim 1, further comprising:
automatically updating a quantity of a controller item in the shopping cart according to the set of radar sectors, wherein a quantity of radar controllers for controlling the set of radar units is indicated by the quantity of the controller item in the shopping cart.

12. The method of claim 1, wherein the set of radar units is a minimum cost set of radar units for fully covering the radar surveillance area.

13. A server system for building a radar system, comprising:
one or more processors; and
a storage device storing instructions that, when executed by the one or more processors, cause the one or more processors to:
display, via a web browser running on a client system, a radar surveillance area on a map on a webpage according to a user input;
automatically arrange a set of radar sectors on the map according to the radar surveillance area, wherein the radar surveillance area is fully covered by the set of radar sectors, and each radar sector is indicative of a coverage area and a location of a corresponding radar unit in a set of radar units of the radar system; and
update a quantity of at least one radar item in a shopping cart displayed on the webpage according to the set of radar sectors, wherein a quantity of each type of radar unit in the set of radar units is indicated by a quantity of a corresponding radar item in the shopping cart.

14. The server system of claim 13, wherein each radar sector is a circular sector, and an area and a vertex position of the circular sector correspond to a coverage area and a location of a corresponding radar unit, respectively.

15. The server system of claim 13, wherein each radar sector in the set of radar sector is indicative of a same azimuth coverage.

16. The server system of claim 13, wherein the step of automatically arranging the set of radar sectors on the map according to the radar surveillance area comprises:
providing a bounding box enclosing the radar surveillance area;
determining a first polygonal grid according to a boundary of the bounding box, wherein the first polygonal grid covers the radar surveillance area and comprises a plurality of first polygons adjacent to each other, and a circumcircle of each first polygon is split into a plurality of first circular sectors; and
arranging the set of radar sectors according to a set of first circular sectors intersecting the radar surveillance area.

17. The server system of claim 16, wherein the step of providing the bounding box to enclose the radar surveillance area comprises:
providing a circumscribed rectangle of the radar surveillance area; and
scaling up the circumscribed rectangle with a scale factor to provide the bounding box, wherein the scale factor is determined according to a shortest edge length of the radar surveillance area and a maximum detection range of radar items in the shopping cart.

18. The server system of claim 16, wherein the step of determining the first polygonal grid according to the boundary of the bounding box comprises:
providing a second polygonal grid inside the bounding box, wherein the second polygonal grid comprises a plurality of second polygons adjacent to each other, and a circumcircle of each second polygon is split into a plurality of second circular sectors;
shifting the second polygonal grid according to a relative position of a center of the radar surveillance area with respect to a center of a second circular sector intersecting the radar surveillance area; and
providing the first polygonal grid according to the shifted second polygonal grid.

19. The server system of claim 16, wherein the step of arranging the set of radar sectors according to the set of first circular sectors comprises:
rotating at least one circumcircle associated with the set of first circular sectors to form a set of second circular sectors intersecting the radar surveillance area, wherein a number of second circular sectors is less than a number of first circular sectors; and
using the set of second circular sectors as the set of radar sectors.

20. The server system of claim 13, wherein the instructions, when executed by the one or more processors, further cause the one or more processors to:
automatically update a quantity of a controller item in the shopping cart according to the set of radar sectors, wherein a quantity of radar controllers for controlling the set of radar units is indicated by a quantity of the controller item in the shopping cart.
